(19) United States
(12) Patent Application Publication
(10) Pub. No.: US 2026/0339574 A1
(43) Pub. Date: Oct. 29, 2026

(54) ALIGNING AND COALESCING RAID GROUPS FOR ADAPTIVE WIDTH

(71) Applicant: Dell Products L.P., Round Rock, TX (US)

(72) Inventors: Kuolin Hua, Natick, MA (US); Kunxiu Gao, Boxborough, MA (US)

(73) Assignee: Dell Products L.P., Round Rock, TX (US)

(21) Appl. No.: 19/186,857

(22) Filed: Apr. 23, 2025

(51) Int. Cl. G06F 3/06

(52) U.S. Cl. CPC G06F 3/0689; G06F 3/0619; G06F 3/0629

(57) ABSTRACT

According to one aspect, a storage system is configured with RAID groups as supported by an initial disk count. The system is adapted to a larger RAID width as more disks are added. Each disk is configured with a number of partitions equal to or, a multiple of, a target RAID width. New disks are added, and existing protection group members are moved and aligned on the new disks. New RAID group members are added to fill vacant partitions left by the moving and sorting existing group members. The new groups may be combined with the existing group members to form combined group members, thus increasing the size of the system and adapting the RAID width.

### BACKGROUND

Protection groups help to avoid data loss by enabling a failed member to be reconstructed. In a typical data storage system, the disk drives are organized as members of a redundant array of independent drives (RAID) or generic Erasure Coding protection group. A (D+P) protection group has D data members and P parity members. The data members store data. The parity members store parity information such as XORs of data values. The parity information enables reconstruction of data in the event that a data member fails. Parity information can be reconstructed from the data on the data members in the event that a parity member fails.

It is sometimes necessary to increase the total storage capacity of a data storage system because the existing storage capacity becomes fully utilized. The storage capacity of a data storage system that uses individual drives as protection group members is increased by adding a one or more new protection groups. RAID-5 arrays that begin with fewer large disks, for example 61 terabyte quad-level cell disks, may encounter increasing data unavailable (DU) and or data loss (DL) risks as capacity expands. Data storage systems, however, may be based on fixed RAID widths that may not be expanded or adapted for capacity upgrades. RAID width may be defined as the sum of the data members and parity members, e.g., (D+P). RAID width determines the number of drives used in a single RAID group to distribute data and parity information. For example, a RAID-5 array with a width of (8+1) includes nine disks in a RAID-5 (8+1) configuration may not be expanded to another RAID width, like a RAID-6 (16+2) configuration, as it grows beyond eighteen disks.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method may include, for a plurality of protection groups using data (D) members and parity (P) members, creating a drive subset using (D+P) drives with (X*(D+P)) partitions such that protection group members are distributed in a manner represented by a matrix of drive columns and partition index rows. The matrix may include a first symmetric submatrix representing a first half of the protection groups and a second symmetric submatrix representing a second half of the protection groups. One or more new drives having (X*(D+P)) partitions may be added until there are (X*(D+P)) drives. The new drives may be added by moving existing protection group members from a selected partition of the (D+P) drives to partitions of the single new drive by relocating each existing protection group member at drive Dₙ of the selected partition of the (D+P) drives to partition Pₙ of the new drive. New protection group members may be added to the selected partition of the (D+P) drives. For each partition index row, the existing protection group members may be combined with the new protection group members to form combined protection group members.

According to another aspect, a system may include a memory and at least one processor that is operatively coupled to the memory, the at least one processor being configured to perform the operations of, for a plurality of protection groups using data (D) members and parity (P) members, creating a drive subset using (D+P) drives with (X*(D+P)) partitions such that protection group members are distributed in a manner represented by a matrix of drive columns and partition index rows. The matrix may include a first symmetric submatrix representing a first half of the protection groups and a second symmetric submatrix representing a second half of the protection groups. One or more new drives having (X*(D+P)) partitions may be added until there are (X*(D+P)) drives. The new drives may be added by moving existing protection group members from a selected partition of the (D+P) drives to partitions of the single new drive by relocating each existing protection group member at drive Dₙ of the selected partition of the (D+P) drives to partition Pₙ of the new drive. New protection group members may be added to the selected partition of the (D+P) drives. For each partition index row, the existing protection group members may be combined with the new protection group members to form combined protection group members.

According to another aspect, a non-transitory computer-readable medium may store one or more processor-executable instructions, which when executed by at least one processor cause the at least one processor to perform the operations of, for a plurality of protection groups using data (D) members and parity (P) members, creating a drive subset using (D+P) drives with (X*(D+P)) partitions such that protection group members are distributed in a manner represented by a matrix of drive columns and partition index rows. The matrix may include a first symmetric submatrix representing a first half of the protection groups and a second symmetric submatrix representing a second half of the protection groups. One or more new drives having (X*(D+P)) partitions may be added until there are (X*(D+P)) drives. The new drives may be added by moving existing protection group members from a selected partition of the (D+P) drives to partitions of the single new drive by relocating each existing protection group member at drive Dₙ of the selected partition of the (D+P) drives to partition Pₙ of the new drive. New protection group members may be added to the selected partition of the (D+P) drives. For each partition index row, the existing protection group members may be combined with the new protection group members to form combined protection group members.

The method, system and non-transitory computer-readable medium may further include, alone or in combination one or more of the following features. The drive subset may comprise a RAID-5 configuration. The drive subset may comprise four drive members and one parity member. The combined protection group members may comprise a RAID-6 configuration. The combined protection group members may comprise eight drive members and two parity members. (X*(D+P)) new drives may be added having (X*(D+P) partitions per new drive. The combined protection group members may be moved from a selected partition of the at least (X*(D+P) drives to partitions of the (X*(D+P)) new drives by relocating each combined protection group member at partition Pₙ of the selected partition to the Pₙ of the (X*(D+P)) new drives. Second new protection group members of a second new protection group may be added to the selected partition of the at least (D+P) new drives. The 2*(X*(D+P)) drives may be split into two drive subsets. At least one of the two drive subsets may characterized by protection group member distribution in a manner represented by a third symmetric matrix. The two drive subsets may comprise RAID-6 configurations.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a storage system, according to one or more aspects of the present disclosure;

FIG. 2 is a diagram of an example expansion of a first RAID width configuration to a second RAID width configurations, according to one or more aspects of the present disclosure;

FIG. 3A illustrates a drive subset matrix including symmetric submatrices, according to one or more aspects of the present disclosure;

FIG. 3B illustrates the drive subset matrix including new drives, according to one or more aspects of the present disclosure;

FIG. 3C illustrates the drive subset matrix including new protection group members, according to one or more aspects of the present disclosure;

FIG. 3D illustrates the drive subset matrix including new disks and storage group members, according to one or more aspects of the present disclosure;

FIG. 3E illustrates a drive subset matrix including combined protection group members, according to one or more aspects of the present disclosure;

FIG. 3F illustrates a template for a target drive subset matrix, according to one or more aspects of the present disclosure;

FIG. 3G illustrates a drive subset matrix including additional drives, according to one or more aspects of the present disclosure;

FIG. 3H illustrates a drive subset matrix including second new protection group members, according to one or more aspects of the present disclosure;

FIG. 3I illustrates a drive subset matrix including moved combined storage group members and distributed second new storage group members, according to one or more aspects of the present disclosure;

FIG. 3J illustrates a symmetric drive subset matrix, according to one or more aspects of the present disclosure;

FIG. 3K illustrates a drive subset matrix including combined protection group members, according to one or more aspects of the present disclosure;

FIG. 4 is a flow diagram of a method for adapting RAID width, according to one or more aspects of the present disclosure.

FIG. 5 is a diagram of an example of a computing device, according to aspects of the disclosure.

### DETAILED DESCRIPTION

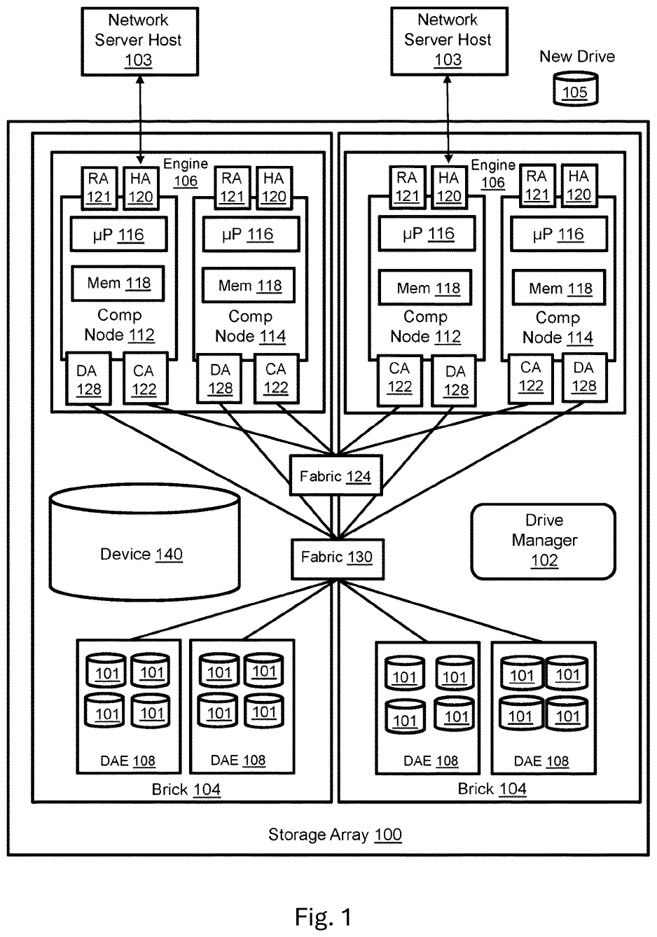

FIG. 1 illustrates a storage array 100 with a drive manager 102 that manages scaling of the storage capacity of storage array protection groups in single drive increments, e.g. adding a single new drive 105. The storage array is one example of a storage area network (SAN), which is one example of a data storage system in which the drive manager could be implemented. The storage array 100 is depicted in a simplified data center environment supporting two network server hosts 103 that run host applications. The hosts 103 include volatile memory, non-volatile storage, and one or more tangible processors. The storage array 100 includes one or more bricks 104. Each brick includes an engine 106 and one or more drive array enclosures (DAEs) 108. Each engine 106 includes a pair of interconnected compute nodes 112, 114 that are arranged in a failover relationship and may be referred to as “storage directors.” Although it is known in the art to refer to the compute nodes of a SAN as “hosts,” that naming convention is avoided in this disclosure to help distinguish the network server hosts 103 from the compute nodes 112, 114. Nevertheless, the host applications could run on the compute nodes, e.g. on virtual machines or in containers. Each compute node includes resources such as at least one multi-core processor 116 and local memory 118. The processor may include central processing units (CPUs), graphics processing units (GPUs), or both. The local memory 118 may include volatile media such as dynamic random-access memory (DRAM), non-volatile memory (NVM) such as storage class memory (SCM), or both. Each compute node includes one or more host adapters (HAs) 120 for communicating with the hosts 103. Each host adapter has resources for servicing input-output commands (IOs) from the hosts. The host adapter resources may include processors, volatile memory, and ports via which the hosts may access the storage array. Each compute node also includes a remote adapter (RA) 121 for communicating with other storage systems. Each compute node also includes one or more drive adapters (DAs) 128 for communicating with managed drives 101 in the DAEs 108. Each drive adapter has processors, volatile memory, and ports via which the compute node may access the DAEs for servicing IOs. Each compute node may also include one or more channel adapters (CAs) 122 for communicating with other compute nodes via an interconnecting fabric 124. The managed drives 101 include non-volatile storage media such as, without limitation, solid-state drives (SSDs) based on EEPROM technology such as NAND and NOR flash memory and hard disk drives (HDDs) with spinning disk magnetic storage media. Drive controllers may be associated with the managed drives as is known in the art. An interconnecting fabric 130 enables implementation of an N-way active-active backend. A backend connection group includes all drive adapters that can access the same drive or drives. In some implementations every drive adapter 128 in the storage array can reach every DAE via the fabric 130. Further, in some implementations every drive adapter in the storage array can access every managed drive 101.

Data associated with instances of the hosted application instances running on the hosts 103 is maintained on the managed drives 101. The managed drives 101 are not discoverable by the hosts but the storage array creates a logical storage device 140 that can be discovered and accessed by the hosts. Without limitation, the logical storage device may be referred to as a storage object, source device, production volume, production device, or production LUN, where the logical unit number (LUN) is a number used to identify logical storage volumes in accordance with the small computer system interface (SCSI) protocol. From the perspective of the hosts 103, the logical storage device 140 is a single drive having a set of contiguous fixed-size logical block addresses (LBAs) on which data used by the instances of the host application resides. However, the host application data is stored at non-contiguous addresses on various managed drives 101. The compute nodes maintain metadata that maps between the logical storage device 140 and the managed drives 101 in order to process IOs from the hosts.

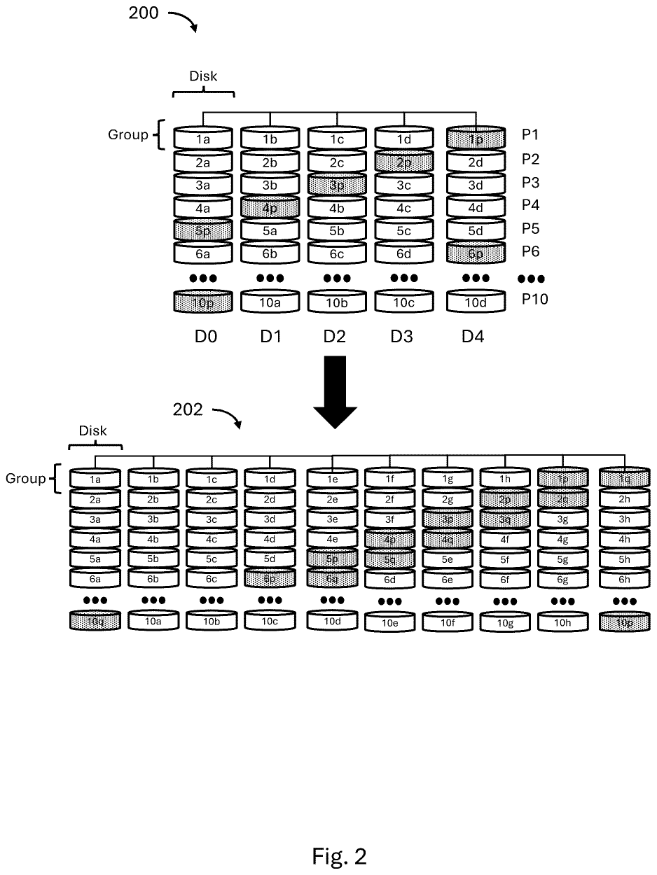

Referring to FIG. 2, the set of managed drives 101 (FIG. 1) of the storage array may organized into independent subsets of drives such as drive subset 200. RAID (D+P) protection groups are implemented on each independent drive subset. Each drive subset may initially be created with (D+P) drives and (X) partitions. A RAID-5 (4+1) implementation is shown so there are five drives D1-D5 on which ten partitions P1-P10 are created. The RAID-5 (4+1) protection groups 1-10 are each based on a single partition across the number of disks provided. Specifically, members of protection group 1 may be the partitions 1n (e.g., 1a, 1b, 1c . . . 1p) of one of the drives, members of protection group 2 may be the partitions 2n of each of the drives, members of protection group 3 may be the partitions 3n of one of the drives, and so on. Operation of the drive manager may be described beginning with the illustrated drive subset 200, but this should not be viewed as a limitation.

According to one or more aspects of the disclosure, the drive manager may provide for growing the width of a given RAID implementation. According to one aspect, an implementation in one RAID configuration may be grown and converted to another RAID configuration, including providing additional parity members. For example, as described herein, a RAID-5 configuration, such as a RAID-5 (4+1) configuration of drive subset 200, may be grown or expanded to a RAID-6 configuration, such as a RAID-6 (8+2) configuration of drive subset 202.

Drive subset 202 may be implemented as a RAID 6 (8+2) configuration in which ten disks may be grouped accordingly, shown in rows of drive subset 202 in which partitions Na-h denote data group members and Np, Nq, denote parity group members, where ‘N’denotes the group number 1-10.

Aspects of the present disclosure provide for leveraging flexible RAID configurations to expand or grow the size of storage arrays with larger RAID widths. According to one aspect, a storage system may be configured with RAID groups as supported by an initial disk count. For example, an array of five disks may be configured in the RAID-5 (4+1) configuration.

The system may be adapted to a larger RAID width as more disks are added. Each disk may be configured with a number of partitions equal to or, a multiple of, a target RAID width. New disks may be added, and existing protection group members may be moved and aligned on the new disks. New RAID group members may be added to fill vacant partitions left by the moving and sorting existing group members. The new groups may be combined with the existing group members to form combined group members, thus doubling (or more) the size of the system and adapting the RAID width. RAID parities may then be recomputed.

According to one or more aspects, the concepts, techniques, and structures disclosed herein may be exemplified by expanding an array of five disks initially implemented in a RAID-5 (4+1) configuration to a RAID-6 (8+2) configuration as the system grows from five disks to ten. One skilled in the art will appreciate that the exemplary initial RAID configurations, widths, and disk numbers are given solely for ease of explanation and that other configurations, widths and numbers of disks may be implemented without deviating from the scope of the disclosure.

As disclosed herein, the process of adapting a RAID-5 (4+1) to a RAID-6 (8+2) may proceed through a number of phases or steps. According to one aspect, a first phase may include initially configuring the disks based on the initial number of disks, for example using 5 disks in a RAID-5 (4+1) configuration. A second phase may involve moving and aligning existing groups and group members as the number of disks increases to ten (e.g., doubles). While the examples given herein may detail doubling the number of disks, one skilled in the art will recognize that other target disk sizes are possible so long as the target width is an integer multiple of the initial number of disks.

A third phase may include adapting the new and existing member groups to a new RAID configuration, such as a RAID-6 (8+2). According to one aspect, every two aligned RAID-5 groups may be coalesced or combined into one RAID-6 group. A fourth phase may include distributing the new RAID-6 groups in a pattern compatible with flexible RAID designs, including growing the cluster of disks from ten to twenty, aligning newly added member groups according to a symmetric matrix, and splitting the cluster into two ten-disk arrays. A fifth phase may include supporting new growth and respective splitting of clusters.

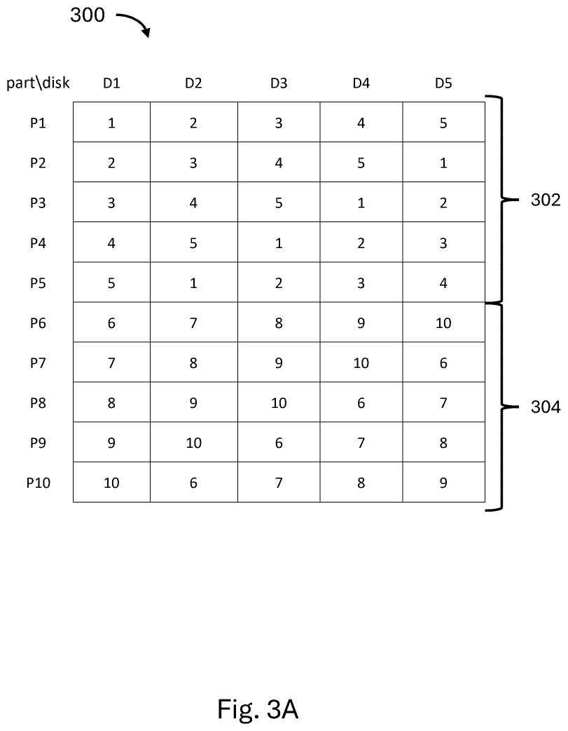

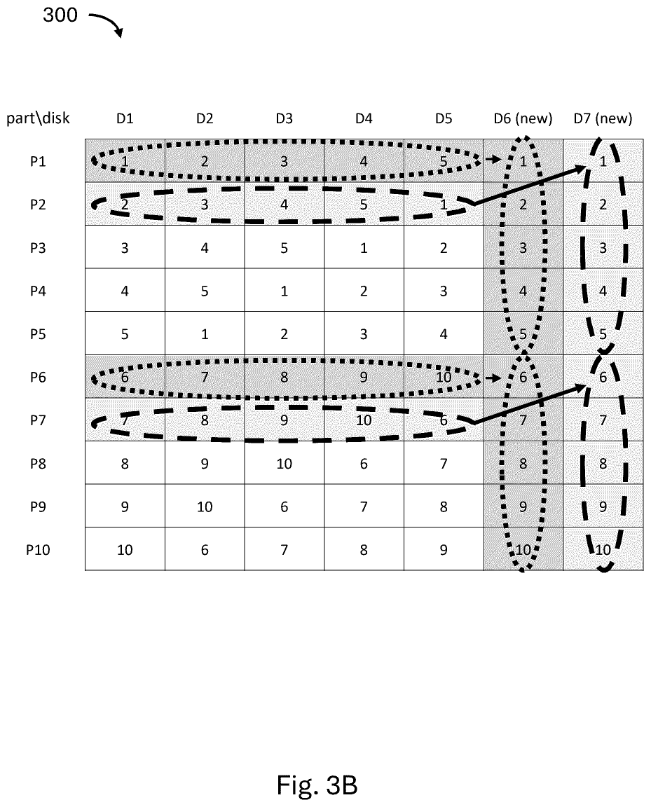

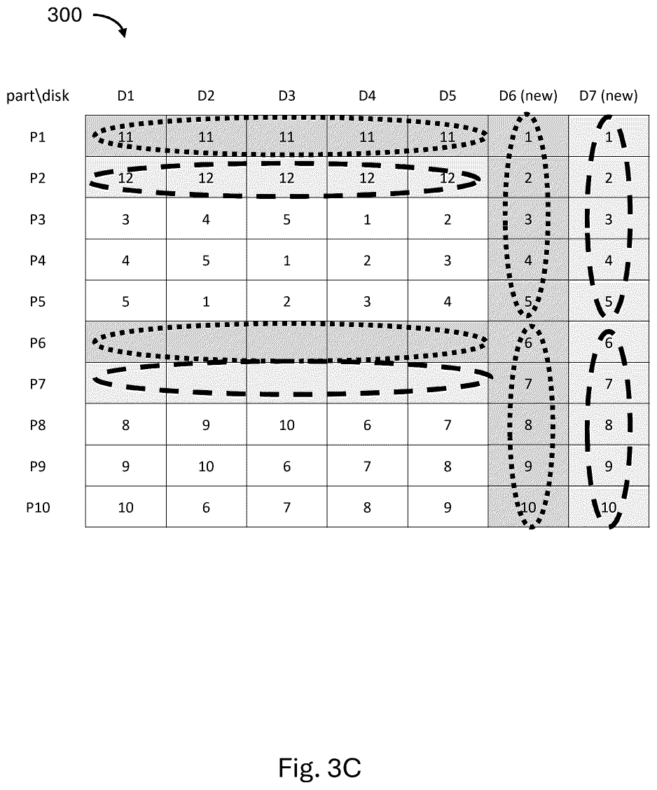

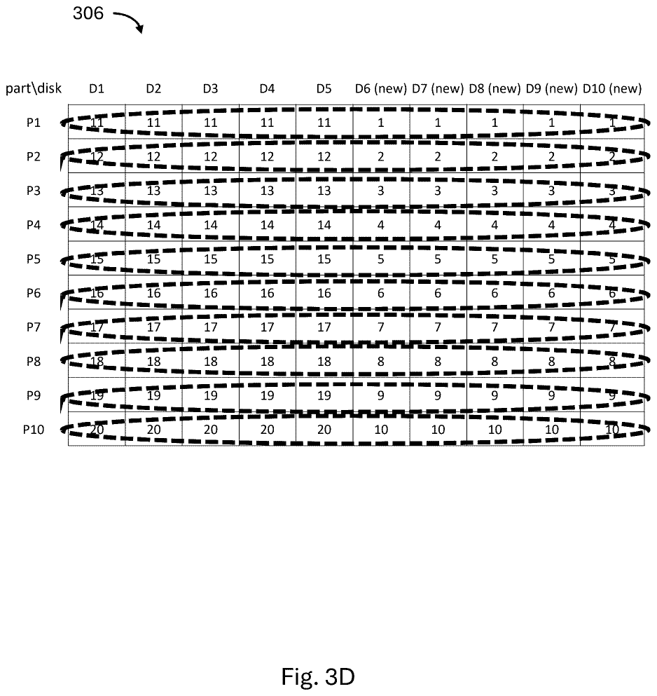

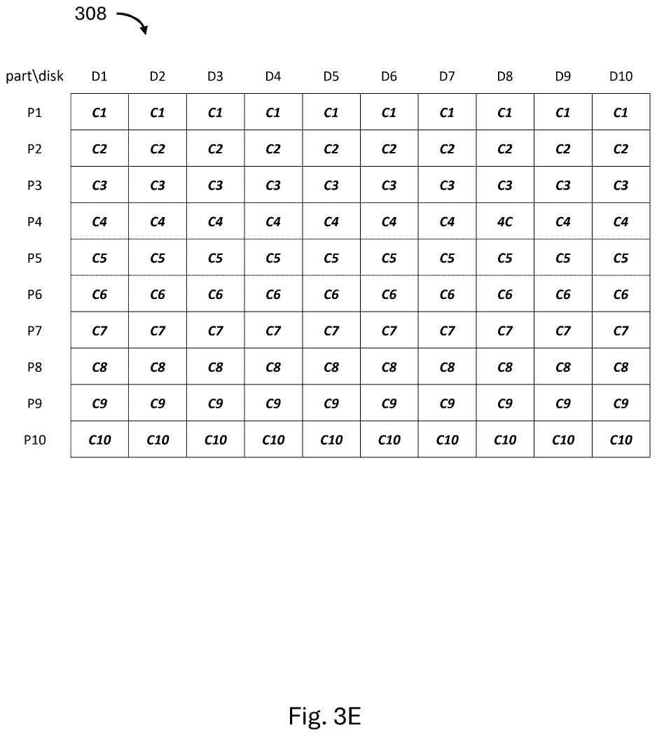

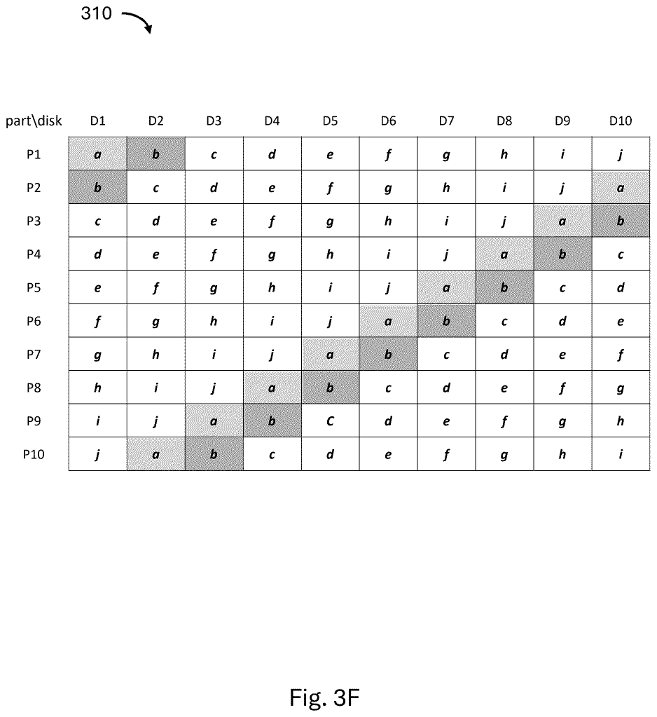

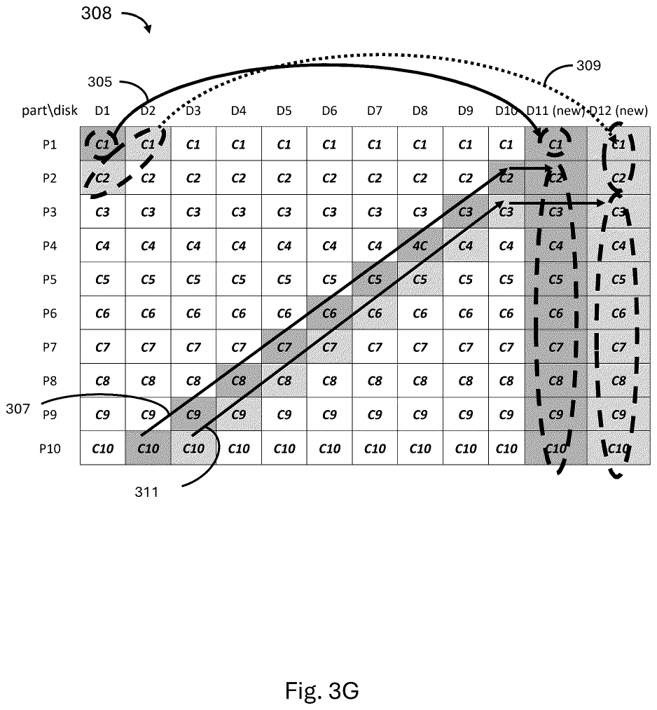

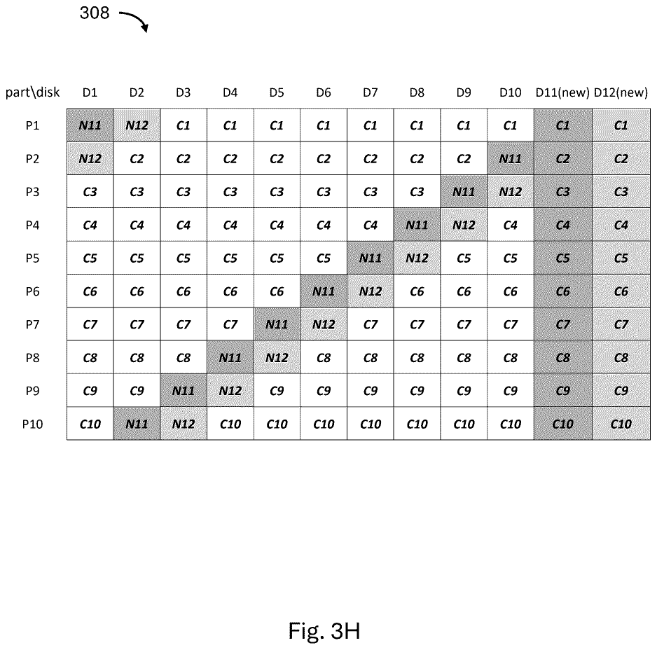

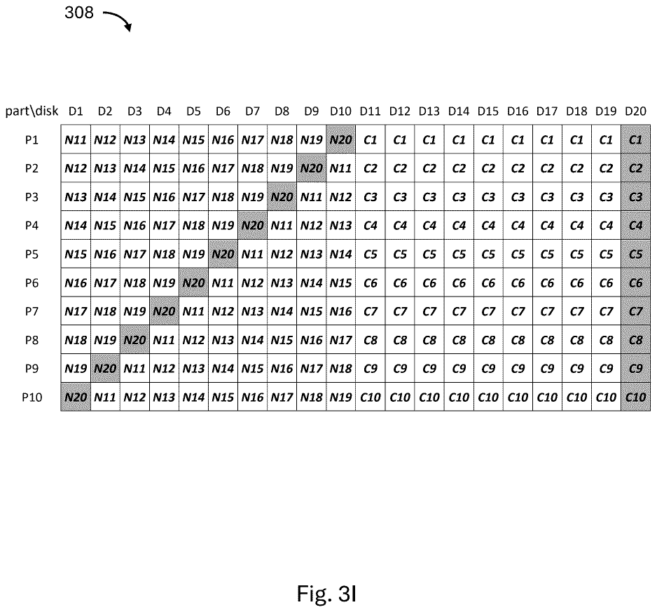

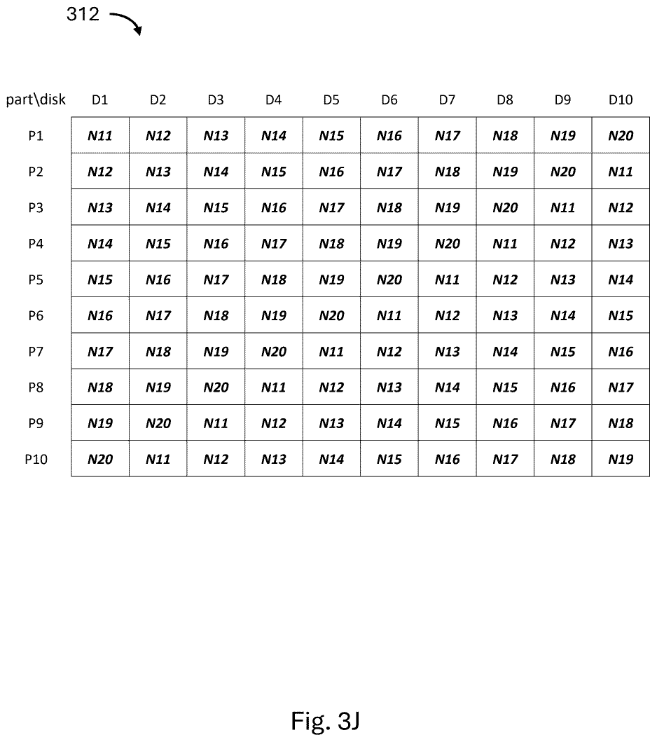

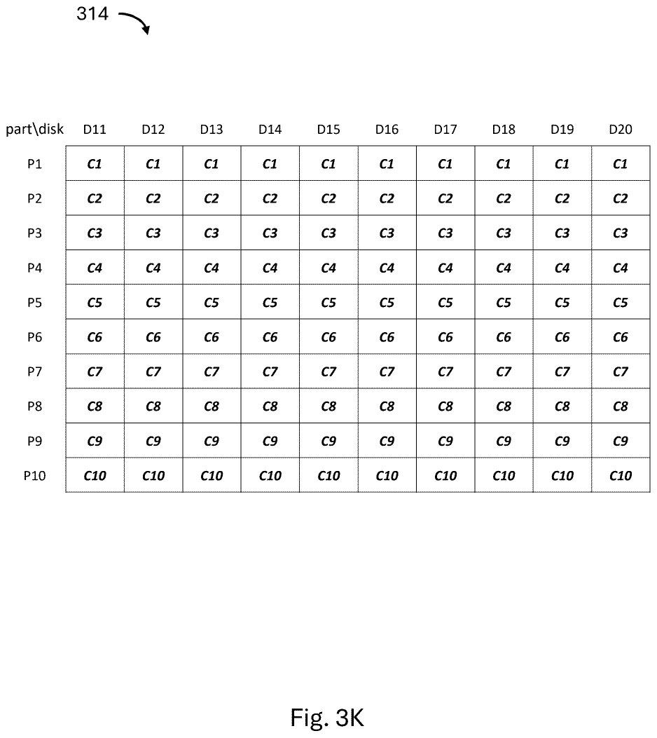

FIG. 3 illustrates a symmetric drive subset matrix 300 representing protection group members across five disks, each disk partitioned into ten partitions. According to one aspect, the number of partitions may be equal to the target width of the current expansion. For example, as the current five disk array is targeted to expand to ten disks, an initial configuration may include ten partitions on each of the five disks.

According to one aspect, the drive subset matrix 300 may be formed by locating selected protection group members into two submatrices, such as first submatrix 302 and second submatrix 304. Each submatrix may be symmetric. For example, the associations between drive partitions and protection group members are accomplished by locating protection group members to different drive partitions such that the protection group members in the matrix exhibit symmetry. In the illustrated example the symmetry is relative to a diagonal running from drive D1, partition P1 to drive D5, partition P5, and drive D1, partition 6 to disk D5, partition P10, respectively. However, other types of symmetry could be implemented. Techniques for generating the submatrices 302, 304 may be found in U.S. Pat. No. 11,403,022, to Hua, et, al, issued on Aug. 2, 2022, the content of which is hereby incorporated by reference in its entirety.

FIG. 3B shows the drive subset matrix 300 with two newly added disks, D6, D7. According to one aspect of the disclosure, the drive manager may sort and move existing RAID group members to the new disks. For example, a first group of members, including members 1-5 in partition P1 across disks D1-D5 may be moved (e.g., rotated) to partitions P1-P5 of new disk D6. Similarly, members 2, 3, 4, 5, 1 in partition P2 across disks D1-D5 may be moved (e.g., rotated) to partitions P1-P5 of new disk D7. The existing group members may also be sorted such that they are ordered numerically 1-5 across partitions P1-P5. Group members across partitions P3, P4 and P5 may be similarly moved and sorted as additional disks D8-D10 (not shown) are added.

In a similar fashion group members 6-10 may also be moved and sorted to new disks. For example, a sixth group of members including members 6-10 in partition P6 across disks D1-D5 may be moved (e.g., rotated) to partitions P6-P10 of new disk D6. Similarly, members 7, 8, 9, 10, 6 in partition P7 across disks D1-D5 may be moved (e.g., rotated) to partitions P6-P10 of new disk D7. The existing group members may also be sorted such that they are ordered numerically 6-10 across partitions P6-P10. Group members across partitions P8, P9 and P10 may be similarly moved and sorted as additional disks D8-D10 (not shown) are added.

According to one aspect, the vacated partitions may be used to create new member groups. FIG. 3C shows the drive subset matrix 300 with newly created group members 11 and 12 located in the partitions P1 and P2, respectively, across the disks D1-D5. FIG. 3C further shows the vacant partitions for P6 and P7 that have yet to be associated with new group members.

FIG. 3D shows an expanded drive subset matrix 306 in which new disks D6-D10 have been added and the existing member groups have been aligned and sorted. The newly created group members 11-20 are respectively associated with partitions across the original five disks. For example, group member 11 is associated with P1 on each of disks D1-D5, group member 12 is associated with P2 on each of disks D1-D5, group member 13 is associated with P3 on each of disks D1-D5, and so forth ending with group member 20 being associated with P10 on each of disks D1-D5.

According to one aspect, the group members aligned across a given partition index row (e.g., encircled groups of members in FIG. 3D) may be combined into combined group members. FIG. 3E shows a combined drive subset matrix 308 in which new groups and group members have been created by coalescing or combining the existing group members with the new group members aligned across the ten partition index rows. For example, group member C1 represents a combination of existing group member 1 and new group member 11 from FIG. 3D. Similarly, group member C2 represents the coalescing of existing group member 2 and new group member 12, group member C3 represents the coalescing of existing group member 3 and new group member 13, and so forth. The resulting combined drive subset matrix 308 is representative of the coalescing of the old RAID configuration into a new RAID configuration with an expanded RAID width. For example, the combined drive subset matrix 308 represents the coalescing of the initial RAID-5(4+1) into a new RAID-6 (8+2) implementation.

According to one aspect of the present disclosure, the drive manager may be configured to distribute the new combined group members into an arrangement that is compatible with flexible RAID configurations and readily expandable to additional disks. FIG. 3F is an exemplary template 310 for a target drive subset matrix according to one or more aspects of the disclosure. In the template 310, group members, represented as group members a-j, are arranged such that each member may be shifted to the left in the subsequent partition, with members on D1 moving wrapping back to D10. For example, Partition P1 may include group members a-j, in alphabetical order, across disks D1-D10. Partition P2 may begin with group member b at D1, followed by members c-j at disks D2-D9, and member a at disk D10. The group members a-j may continue to be shifted to the left for each subsequent partition until P10, which may include group member j at disk D1 and group members a-i at disks D2-D10, respectively. The distribution of group elements as reflected in the template 310 provides compatibility with flexible RAID systems and configurations while also allowing for potential growth of the array by adding more disks.

Returning the example implementation described above, FIG. 3G shows the drive subset matrix 308 as the redistribution process begins to move towards a target drive subset matrix like that shown in FIG. 3F. According to one aspect, new disks D11 may be added in which the group member C1 from partition P1, disk D1 is moved to partition P1, disk D11, shown by arrow 305. Group elements C2-C10 may be moved from partitions and disks according to the diagonal line 307. That is, the group member C2 in partition P2, disk D2 is moved to partition P2, disk D11; group member C3 in partition P3, disk D9 is moved to partition P3, D11; group member C4 in partition P4, disk D8 is moved to partition P4, disk D11, and so forth until group member C10 in partition P10, disk D2 is moved to partition P10, D11.

According to one aspect, another disk, D12, may be added and combined group members may be moved to its partitions in a similar way. For example, group member C1 from partition P1, disk D2 is moved to partition P1, disk D12 and group member C2 in partition P2, disk D1 is moved to partition P2, disk D12, shown by arrow 309. Group elements C3-C10 may be moved from partitions and disks according to the diagonal line 311. That is, group member C3 in partition P3, disk D10 is moved to partition P3, D12; group member C4 in partition P4, disk D9 is moved to partition P4, disk D12, and so forth until group member C10 in partition P10, disk D3 is moved to partition P10, D12.

According to one aspect, new group members may be added to the vacancies left by the movement of the combined group members to the new disks. FIG. 3H shows the drive subset matrix 308 with new group members N11 and N12 filling the vacancies from the move of members C1-C10 to new disks D11 and D12, respectively.

New disks may continue to be added in such a manner until the number of disks doubles (or is an integer multiple). The combined group members may be moved and vacancies filled with new group members according to the above process. FIG. 3I shows the drive subset matrix 308 grown to twenty disks with new group members N11-N20 distributed on one half of the matrix 308 (disks D1-D10) and combined group members C1-C10 distributed on the other half (new disks D11-D20). The new group members may be distributed according to the target drive subset matrix, like that in the template 319 of FIG. 3F.

According to one aspect, the drive subset matrix 308 may be split into two matrices, a first drive subset matrix 312, shown in FIG. 3J and a second drive submatrix 314, shown in FIG. 3K. In one aspect, the first drive subset matrix 312 follows the group member distribution of the target template 319 (FIG. 3F). The first drive subset matrix 312 may be a symmetric matrix where the transpose of the matrix yields the same matrix. According to one aspect, the first drive subset matrix 312 may include new group members N11-N20 in a RAID 6 (8+2) configuration on disks D1-D10.

According to one aspect, the second drive subset matrix 314 includes combined group members C1-C10 according to the original distribution generated when the combined group members were coalesced, shown and described above in connection with FIG. 3E. The second drive subset matrix 314 may be configured in a RAID-6 (8+2) implementation on disks D11-D20. The second drive subset matrix 314 and its distribution may support additional cycles of growth and splitting, in one aspect, by repeating the process as described above and shown in FIGS. 3E-3K.

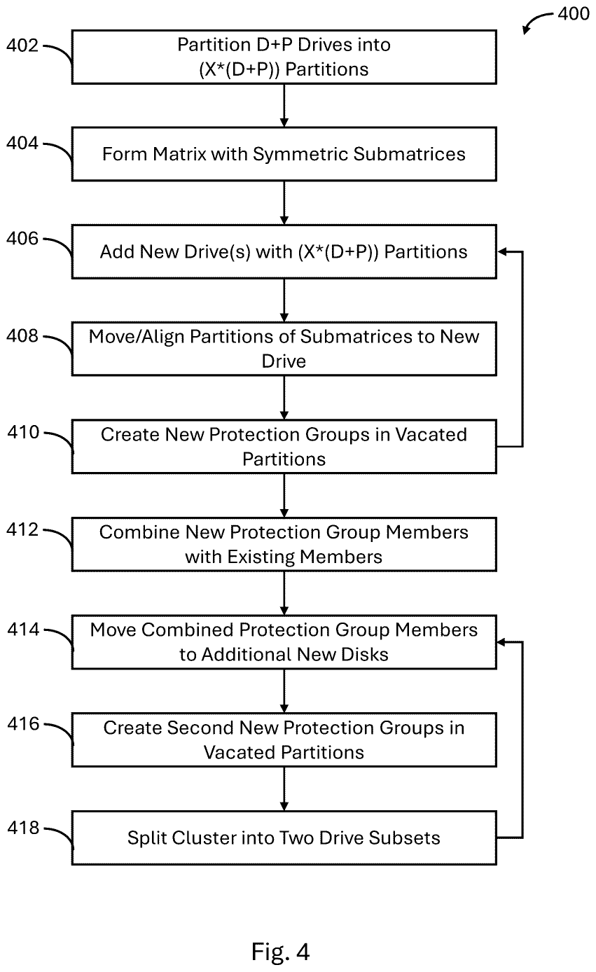

FIG. 4 is a flow diagram of a method 400 of adapting RAID width, according to aspects of the present disclosure. Shown in block 402, a number of drives in a RAID configuration with (D+P) drives may be partitioned into X*(D+P) partitions. For example, as described herein, a RAID-5 (4+1) may include five drives. According to one aspect the five drives may be partitioned into ten partitions (e.g., X*(D+P), where X=2, D=4, and P=1). According to one aspect, the number of partitions X*(D+P) may be the target number of drives to which the array may be expanded. Further, while X as described herein may be set to two, one skilled in the art will appreciate that other values of X may be implemented without deviating from the scope of the disclosure. According to one aspect, X may be an integer ensuring the target number of drives will be a multiple of the original drives. Each partition may include a protection group member.

As shown in block 404, a drive subset matrix may be formed including submatrices with the protection group members, as described herein. In the example of a RAID-5 (4+1) being expanded to ten drives, the drive subset matrix may include two submatrices, each submatrix being a symmetric matrix. Shown in block 406, a new drive may be added and configured with X*(D+P) partitions. Existing group members may be moved to and realigned in the new drive, as shown in block 408. New protection groups may be created and located in the vacated partitions of the original drives, shown in block 410. The steps shown in blocks 406-410 may be repeated until X*(D+P) drives are present in the drive subset matrix.

Shown in block 412, new protection group members may be combined with existing group members across each of the X*(D+P) partitions to form combined group members, as described herein. Shown in block 414, additional new disks may be added and the combined group members may be moved to the additional disks. According to one aspect, another X*(D+P) drives may be added.

As the drives are added, as described herein, second new protection group members may be added to the vacancies left by moving the combined group members to the new disks, shown in block 416. Once the additional X*(D+P) drives have been added, combined group members moved, and vacancies filled with second new protection group members, the resulting drive subset cluster matrix may be split, shown in block 418. According to one aspect, the first drive subset matrix may be a symmetric matrix. The second drive subset matrix may be similar to the drive subset matrix resulting from the combination of protection groups shown in block 412.

According to one aspect, the second drive subset matrix may be grown and split as the array needs to expand by repeating the steps shown in blocks 414-418.

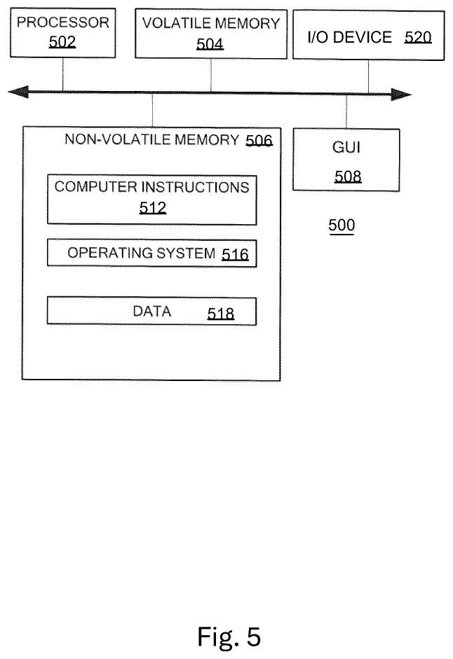

Referring to FIG. 5, in some embodiments, a computing device 500 may include processor 502, volatile memory 504 (e.g., RAM), non-volatile memory 506 (e.g., a hard disk drive, a solid-state drive such as a flash drive, a hybrid magnetic and solid-state drive, etc.), graphical user interface (GUI) 508 (e.g., a touchscreen, a display, and so forth) and input/output (I/O) device 520 (e.g., a mouse, a keyboard, etc.). Non-volatile memory 506 stores computer instructions 512, an operating system 516 and data 518 such that, for example, the computer instructions 512 are executed by the processor 502 out of volatile memory 504. Program code may be applied to data entered using an input device of GUI 508 or received from I/O device 520.

Described herein are concepts, techniques, and structures for growing RAID (or generic Erasure Coding) configurations using variable widths. While storage efficiency and resiliency of known flexible RAID (of Generic Erasure Encoding) configurations are not able to adapt to capacity upgrades, aspects of the present disclosure support adaptive widths as disks are added and capacity is expanded, providing more efficient and resilient data storage with larger widths.

As used herein, the term “I/O request” or simply “I/O” may be used to refer to an input or output request. In some embodiments, an I/O request may refer to a data read or write request.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refer to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
for a plurality of protection groups using data (D) members and parity (P) members, creating a drive subset using (D+P) drives with (X*(D+P)) partitions such that protection group members are distributed in a manner represented by a matrix of drive columns and partition index rows, wherein the matrix includes a first symmetric submatrix representing a first half of the protection groups and a second symmetric submatrix representing a second half of the protection groups;
adding, one or more new drives until there are (X*(D+P)) drives, the new drives having (X*(D+P)) partitions to the drive subset by:
moving existing protection group members from a selected partition of the (D+P) drives to partitions of the single new drive by relocating each existing protection group member at drive Dₙ of the selected partition of the (D+P) drives to partition Pₙ of the new drive; and
adding new protection group members to the selected partition of the (D+P) drives; and
for each partition index row, combining the existing protection group members with the new protection group members to form combined protection group members.

2. The method of claim 1 wherein drive subset comprises a RAID-5 configuration.

3. The method of claim 2 wherein the drive subset comprises four drive members and one parity member.

4. The method of claim 1 wherein the combined protection group members comprise a RAID-6 configuration.

5. The method of claim 4 wherein the combined protection group members comprise eight drive members and two parity members.

6. The method of claim 1 further comprising:
adding (X*(D+P)) new drives having (X*(D+P) partitions per new drive;
moving the combined protection group members from a selected partition of the at least (X*(D+P) drives to partitions of the (X*(D+P)) new drives by relocating each combined protection group member at partition Pₙ of the selected partition to the Pₙ of the (X*(D+P)) new drives;
adding second new protection group members of a second new protection group to the selected partition of the at least (D+P) new drives; and
splitting the 2*(X*(D+P)) drives into two drive subsets, wherein at least one of the two drive subsets is characterized by protection group member distribution in a manner represented by a third symmetric matrix.

7. The method of claim 6 wherein the two drive subsets comprise one of: a RAID-6 configuration or an Erasure Coding configuration.

8. A system comprising:
a memory; and
at least one processor that is operatively coupled to the memory, the at least one processor being configured to perform the operations of:
for a plurality of protection groups using data (D) members and parity (P) members, creating a drive subset using (D+P) drives with (X*(D+P)) partitions such that protection group members are distributed in a manner represented by a matrix of drive columns and partition index rows, wherein the matrix includes a first symmetric submatrix representing a first half of the protection groups and a second symmetric submatrix representing a second half of the protection groups;
adding, one or more new drives until there are (X*(D+P)) drives, the new drives having (X*(D+P)) partitions to the drive subset by:
moving existing protection group members from a selected partition of the (D+P) drives to partitions of the single new drive by relocating each existing protection group member at drive Dₙ of the selected partition of the (D+P) drives to partition Pₙ of the new drive; and
adding new protection group members to the selected partition of the (D+P) drives;
for each partition index row, combining the existing protection group members with the new protection group members to form combined protection group members.

9. The system of claim 8 wherein drive subset comprises a RAID-5 configuration.

10. The system of claim 9 wherein the drive subset comprises four drive members and one parity member.

11. The system of claim 10 wherein the combined protection group members comprise a RAID-6 configuration.

12. The system of claim 10 wherein the combined protection group members comprise eight drive members and two parity members.

13. The system of claim 8 further comprising:
adding (X*(D+P)) new drives having (X*(D+P)) partitions per new drive;
moving the combined protection group members from a selected partition of the at least (X*(D+P)) new drives to partitions of the (X*(D+P)) new drives by relocating each combined protection group member at partition Pₙ of the selected partition to the Pₙ of the (X*(D+P)) new drives;
adding second new protection group members of a second new protection group to the selected partition of the at least (D+P) new drives; and
splitting the 2*(X(D+P)) drives into two drive subsets, wherein at least one of the two drive subsets is characterized by protection group member distribution in a manner represented by a third symmetric matrix.

14. The system of claim 13 wherein the two drive subsets comprise one of: a RAID-6 configuration or an Erasure Coding configuration.

15. A non-transitory computer-readable medium storing one or more processor-executable instructions, which when executed by at least one processor cause the at least one processor to perform the operations of:
for a plurality of protection groups using data (D) members and parity (P) members, creating a drive subset using (D+P) drives with (X*(D+P)) partitions such that protection group members are distributed in a manner represented by a matrix of drive columns and partition index rows, wherein the matrix includes a first symmetric submatrix representing a first half of the protection groups and a second symmetric submatrix representing a second half of the protection groups;
adding, one or more new drives until there are (X*(D+P)) drives, new drives having (X*(D+P)) partitions to the drive subset by:
moving existing protection group members from a selected partition of the (D+P) drives to partitions of the single new drive by relocating each existing protection group member at drive Dₙ of the selected partition of the (D+P) drives to partition Pₙ of the new drive; and
adding new protection group members to the selected partition of the (D+P) drives; and
for each partition index row, combining the existing protection group members with the new protection group members to form combined protection group members.

16. The non-transitory computer-readable medium of claim 15 wherein drive subset comprises a RAID 5 configuration.

17. The non-transitory computer-readable medium of claim 16 wherein the drive subset comprises four drive members and one parity member.

18. The non-transitory computer-readable medium of claim 15 wherein the combined protection group members comprise a RAID-6 configuration.

19. The non-transitory computer-readable medium of claim 18 wherein the combined protection group members comprise eight drive members and two parity members.

20. The non-transitory computer-readable medium of claim 15 further comprising instructions to perform the operations of:
adding (X*(D+P)) new drives having (X*(D+P)) partitions per new drive;
moving the combined protection group members from a selected partition of the at least (X*(D+P) drives to partitions of the (X*(D+P)) new drives by relocating each combined protection group member at partition Pₙ of the selected partition to the Pₙ of the (X*(D+P)) new drives;
adding second new protection group members of a second new protection group to the selected partition of the at least (D+P) new drives; and
splitting the 2*X*(D+P) drives into two drive subsets, wherein at least one of the two drive subsets is characterized by protection group member distribution in a manner represented by a third symmetric matrix.
